(19) United States
(12) Patent Application Publication
(10) Pub. No.: US 2024/0202277 A1
(43) Pub. Date: Jun. 20, 2024

(54) APPARATUS AND METHOD FOR MATRIX MULTIPLICATION

(71) Applicant: ELECTRONICS AND TELECOMMUNICATIONS RESEARCH INSTITUTE, Daejeon (KR)

(72) Inventor: Joo-Hyun LEE, Daejeon (KR)

(73) Assignee: ELECTRONICS AND TELECOMMUNICATIONS RESEARCH INSTITUTE, Daejeon (KR)

(21) Appl. No.: 18/538,145

(22) Filed: Dec. 13, 2023

(30) Foreign Application Priority Data
Dec. 15, 2022 (KR) 10-2022-0176157
Jun. 14, 2023 (KR) 10-2023-0076384

(51) Int. Cl. G06F 17/16; G06F 7/544

(52) U.S. Cl. CPC G06F 17/16; G06F 7/5443

(57) ABSTRACT

Disclosed herein is an apparatus and method for a matrix multiplication operation. The apparatus may include memory for storing first matrix data and second matrix data, an X buffer for storing the first matrix data, a Y buffer for storing the second matrix data, multiple operation units for performing Multiply-and-Accumulate (MAC) operations in parallel on the data input from the X buffer and the Y buffer, and a data loader for storing the first matrix data and the second matrix data read from the memory in the X buffer and the Y buffer, respectively.

### CROSS REFERENCE TO RELATED APPLICATIONS

This application claims the benefit of Korean Patent Applications No. 10-2022-0176157, filed Dec. 15, 2022, and No. 10-2023-0076384, filed Jun. 14, 2023, which are hereby incorporated by reference in their entireties into this application.

### BACKGROUND OF THE INVENTION

### 1. Technical Field

The disclosed embodiment relates to a hardware operation unit for a large matrix multiplication operation based on the Basic Linear Algebra Subroutines (BLAS) library.

### 2. Description of the Related Art

Large-matrix multiplication operations used in the fields of Graphics Processing Units (GPUs) and High-Performance Computing (HPC) are also used as a key operation for measuring the computational performance of Neural Processing Units (NPUs) in an Artificial Intelligence (AI) field, which has recently received a lot of attention.

A hardware architecture capable of efficiently processing matrix multiplication operations can provide key functions for improving the computational performance of chips in various fields.

In most science and technology fields, software for matrix multiplication operations is developed using the Basic Linear Algebra Subroutines (BLAS) library or libraries similar thereto.

### SUMMARY OF THE INVENTION

An object of the disclosed embodiment is to efficiently process a matrix multiplication operation based on the BLAS library.

Another object of the disclosed embodiment is to prevent latency caused by processing a transpose operation in a matrix multiplication operation based on the BLAS library.

An apparatus for a matrix multiplication operation according to an embodiment may include memory for storing data of a first matrix and data of a second matrix, an X buffer for storing the data of the first matrix, a Y buffer for storing the data of the second matrix, multiple operation units for performing Multiply-and-Accumulate (MAC) operations in parallel on data input from the X buffer and the Y buffer, and a data loader for storing the data of the first matrix read from the memory in the X buffer and storing the data of the second matrix read from the memory in the Y buffer.

Here, each of the multiple operation units for performing the MAC operations in parallel may include a multiplier for multiplying a value output from the X buffer and a value output from the Y buffer, a partial sum register, and an adder for adding an output value of the multiplier and a value stored in the partial sum register and again storing the result value of addition in the partial sum register.

Here, the data loader may be configured to store pieces of matrix data in the X buffer or the Y buffer in a first mode or a second mode, to simultaneously load the pieces of matrix data into respective First-In First-Out (FIFO) units inside the X buffer or the Y buffer in parallel in the first mode, and to load the pieces of matrix data into one of the FIFO units inside the X buffer or the Y buffer in the second mode.

Here, when multiplication of the first matrix and the second matrix is performed, the data loader may store the data of the first matrix in the X buffer by loading the same in the first mode and store the data of the second matrix in the Y buffer by loading the same in the second mode.

Here, when multiplication of the transpose matrix of the first matrix and the second matrix is performed, the data loader may store the data of the first matrix in the X buffer by loading the same in the second mode and store the data of the second matrix in the Y buffer by loading the same in the second mode.

Here, when multiplication of the first matrix and the transpose matrix of the second matrix is performed, the data loader may store the data of the first matrix in the X buffer by loading the same in the first mode and store the data of the second matrix in the Y buffer by loading the same in the first mode.

Here, when multiplication of the transpose matrix of the first matrix and the transpose matrix of the second matrix is performed, the data loader may store the data of the first matrix in the X buffer by loading the same in the second mode and store the data of the second matrix in the Y buffer by loading the same in the first mode.

Here, each of the X buffer and the Y buffer is formed of two buffers, and while a predetermined number of pieces of matrix data is being output from one of the buffers, a predetermined number of pieces of matrix data may be stored in the other one of the buffers.

Here, the apparatus for a matrix multiplication operation according to an embodiment may further include a data saver for simultaneously outputting values stored in the respective partial sum registers of the multiple operation units for performing the MAC operations in parallel and storing the values in the memory.

A method for a matrix multiplication operation according to an embodiment may include loading data of a first matrix and data of a second matrix from memory into an X buffer and a Y buffer, respectively, and performing simultaneous MAC operations in parallel on the data of the first matrix, which is loaded into the X buffer, and the data of the second matrix, which is loaded into the Y buffer, multiple times.

Here, the MAC operation may comprise multiplication of a value output from the X buffer and a value output from the Y buffer, addition of the result value of the multiplication and a previously calculated partial sum, and update of the partial sum with the result value of the addition.

Here, loading the data may comprise storing pieces of matrix data in the X buffer or the Y buffer in a first mode or a second mode, the pieces of matrix data may be simultaneously loaded into respective FIFO units inside the X buffer or the Y buffer in parallel in the first mode, and the pieces of matrix data may be loaded into one of the FIFO units inside the X buffer or the Y buffer in the second mode.

Here, loading the data may comprise storing the data of the first matrix in the X buffer by loading the same in the first mode and storing the data of the second matrix in the Y buffer by loading the same in the second mode when multiplication of the first matrix and the second matrix is performed.

Here, loading the data may comprise storing the data of the first matrix in the X buffer by loading the same in the second mode and storing the data of the second matrix in the Y buffer by loading the same in the second mode when multiplication of the transpose matrix of the first matrix and the second matrix is performed.

Here, loading the data may comprise storing the data of the first matrix in the X buffer by loading the same in the first mode and storing the data of the second matrix in the Y buffer by loading the same in the first mode when multiplication of the first matrix and the transpose matrix of the second matrix is performed.

Here, loading the data may comprise storing the data of the first matrix in the X buffer by loading the same in the second mode and storing the data of the second matrix in the Y buffer by loading the same in the first mode when multiplication of the transpose matrix of the first matrix and the transpose matrix of the second matrix is performed.

Here, each of the X buffer and the Y buffer is formed of two buffers, and while a predetermined number of pieces of matrix data is being output from one of the buffers, a predetermined number of pieces of matrix data may be stored in the other one of the buffers.

The method for a matrix multiplication operation according to an embodiment may further include simultaneously outputting partial sums, which are the results of performing the simultaneous MAC operations in parallel multiple times, and storing the partial sums in the memory.

An apparatus for a matrix multiplication operation according to an embodiment may include memory for storing data of a first matrix and data of a second matrix, an X buffer for storing the data of the first matrix, a Y buffer for storing the data of the second matrix, multiple operation units for performing MAC operations in parallel on data input from the X buffer and the Y buffer, a data loader for storing the data of the first matrix read from the memory in the X buffer and storing the data of the second matrix read from the memory in the Y buffer, and a data saver for simultaneously outputting values stored in respective partial sum registers of the multiple operation units for performing the MAC operations in parallel and storing the values in the memory.

Here, the data loader may be configured to store pieces of matrix data in the X buffer or the Y buffer in a first mode or a second mode, to simultaneously load the pieces of matrix data into respective FIFO units inside the X buffer or the Y buffer in parallel in the first mode, and to load the pieces of matrix data into one of the FIFO units inside the X buffer or the Y buffer in the second mode.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an API for a matrix multiplication operation defined in the BLAS library;

FIG. 2 is a view for explaining a general matrix multiplication operation process;

FIG. 3 is a structural diagram of a processor for a general BLAS operation;

FIG. 4 is a block diagram of an apparatus for a matrix multiplication operation according to an embodiment;

FIG. 5 is an internal configuration diagram of a Multiply-and-Accumulate (MAC) unit according to an embodiment;

FIG. 6 is a conceptual diagram for explaining a matrix multiplication operation according to an embodiment;

FIG. 7 is a view for explaining an operation of a MAC unit array according to an embodiment;

FIG. 8 is an exemplary view of an operation when a buffer mode is a first mode according to an embodiment;

FIG. 9 is an exemplary view of an operation when a buffer mode is a second mode according to an embodiment;

FIG. 10 is an exemplary view for explaining matrix multiplication A×B in an apparatus for a matrix multiplication operation according to an embodiment;

FIG. 11 is an exemplary view for explaining matrix multiplication A^{T}×B in an apparatus for a matrix multiplication operation according to an embodiment;

FIG. 12 is an exemplary view for explaining matrix multiplication A×B^{T} in an apparatus for a matrix multiplication operation according to an embodiment;

FIG. 13 is an exemplary view for explaining matrix multiplication A^{T}× B^{T} in an apparatus for a matrix multiplication operation according to an embodiment;

FIG. 14 is a flowchart for explaining a method for a matrix multiplication operation according to an embodiment; and

FIG. 15 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

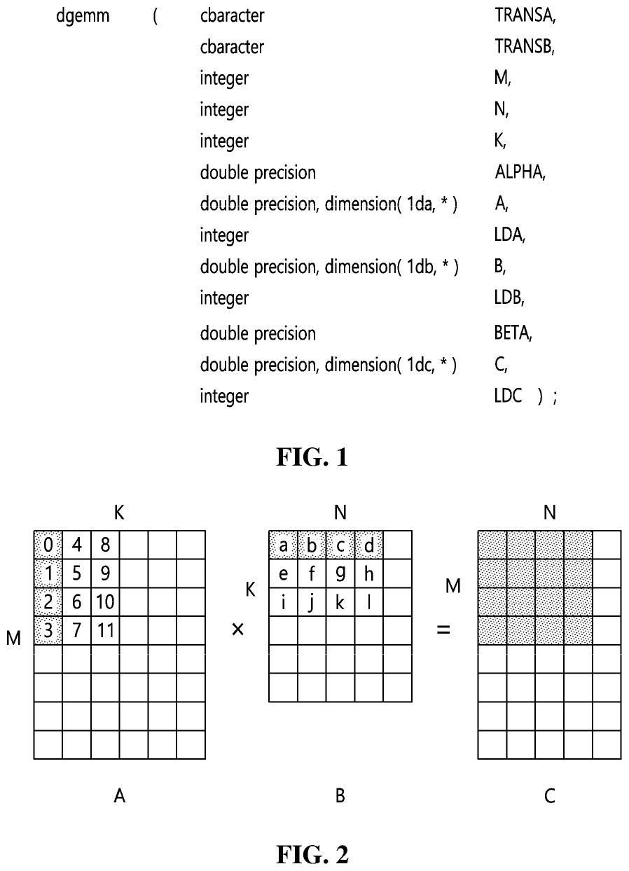

FIG. 1 is a view illustrating an API for a matrix multiplication operation defined in the BLAS library.

The API illustrated in FIG. 1 is an API for calculating multiplication and addition between matrices, and the operation of the API may be represented as shown in Equation (1) below:

$$\begin{matrix}C = α \cdot A \cdot B + β \cdot C \\ C = α \cdot {A}^{T} \cdot B + β \cdot C \\ C = α \cdot A \cdot {B}^{T} + β \cdot C \\ C = α \cdot {A}^{T} \cdot {B}^{T} + β \cdot C\end{matrix} \qquad ( 1 )$$

An embodiment relates to multiplication of matrices, which accounts for most of operations in the BLAS functions. Hereinbelow, multiplication of matrices A and B in Equation (1) will be described, and the case in which α=1 and β=0 are set will be described for convenience of description.

Meanwhile, in the API of the BLAS library represented as Equation (1), the function of transposing matrix A and matrix B may be selectively set. However, when the size of the matrix increases, memory access for transposing the matrix results in latency, which greatly affects the overall operation performance.

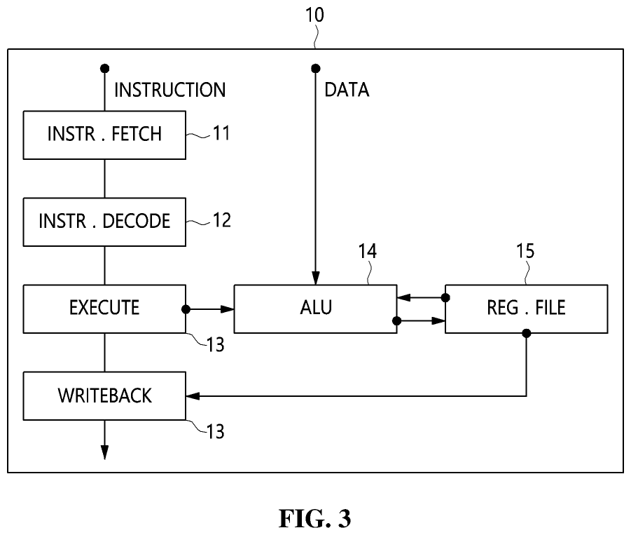

FIG. 2 is a view for explaining a general matrix multiplication operation process, and FIG. 3 is a structural diagram of a processor for a general BLAS operation.

Referring to FIG. 2, a general matrix multiplication operation is processed by sequentially performing operations by accessing the data of matrix A and the data of matrix B and storing result values.

That is, in order to process matrix multiplication A×B illustrated in FIG. 2, it is necessary to load the data of a row of matrix A and the data of a column of matrix B and calculate an inner product, which is the sum of the products of corresponding elements.

That is, when this operation is processed using a general processor, the operation is performed on the piece of data of the matrices in FIG. 2 (14) while instructions are sequentially being processed (11, 12, and 13), and the intermediate result value is reused after being stored in a register file 15, as shown in FIG. 3. After the result value is obtained, the value in the register file 15 is stored in memory 13.

That is, according to the conventional method, matrix multiplication is performed through sequential multiplication operations using a single CPU, which results in latency.

Further, when a transpose operations is performed, the speed is rapidly decreased.

In an embodiment, in order to overcome the above-mentioned problem, a plurality of Multiply-and-Accumulate (MAC) units simultaneously operate in parallel, whereby the performance of a matrix multiplication operation may be improved.

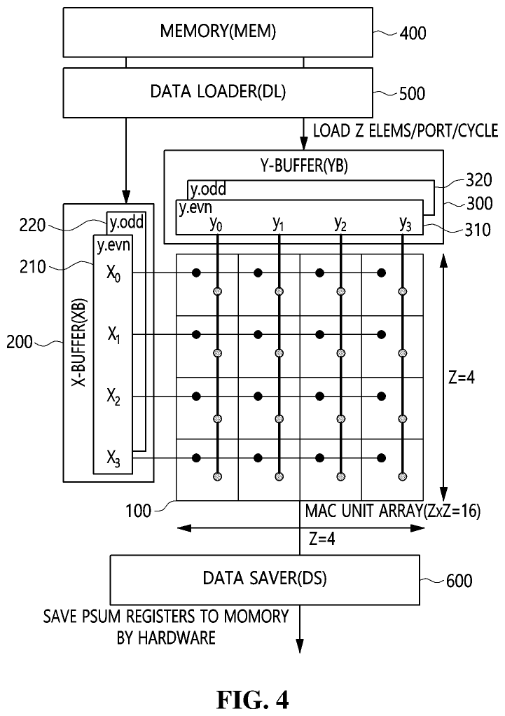

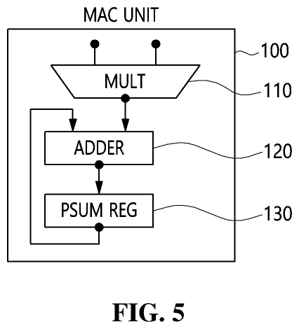

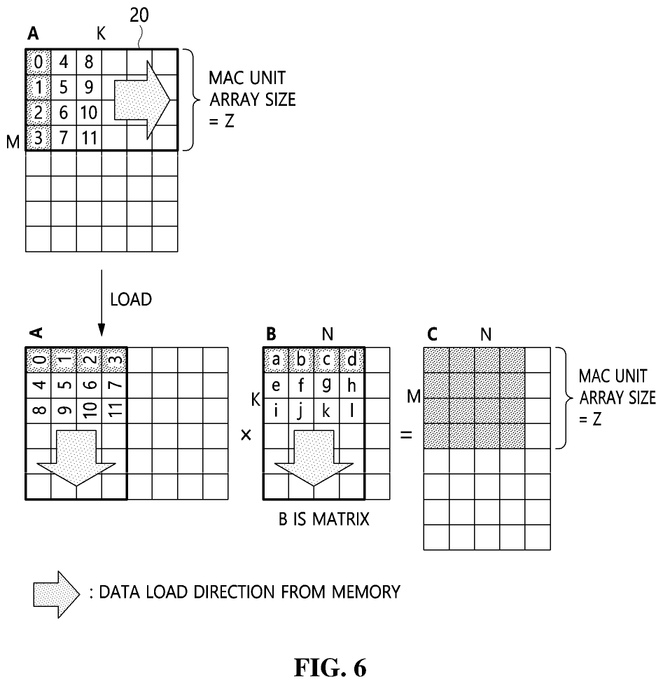

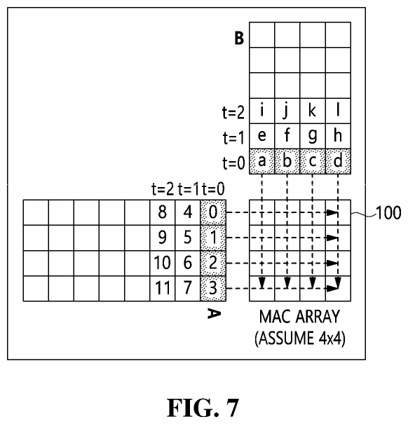

FIG. 4 is a block diagram of an apparatus for a matrix multiplication operation according to an embodiment, FIG. 5 is an internal configuration diagram of a MAC unit according to an embodiment, FIG. 6 is a conceptual diagram for explaining a matrix multiplication operation according to an embodiment, and FIG. 7 is a view for explaining the operation of a MAC unit array according to an embodiment.

Referring to FIG. 4, the apparatus for a matrix multiplication operation according to an embodiment may include a MAC unit array 100, an X-buffer 200, a Y-buffer 300, memory 400, a data loader (DL) 500, and a data saver (DS) 600.

Multiple MAC units, each of which performs a Multiply-and-Accumulate (MAC) operation, are arranged in the MAC unit array 100. For example, 16 MAC units (Z×Z=16, Z=4) may be arranged, as illustrated in FIG. 4.

Here, the number of MAC units may be flexibly set depending on a hardware area and performance requirements.

Referring to FIG. 5, each of the MAC units may include a multiplier 110, an adder 120, and a partial sum register (PSUM REG) 130.

That is, the multiplier 110 multiplies two pieces of data input thereto and outputs the result thereof. Then, the adder 120 adds the result of the multiplication and the cumulative value stored in the partial sum register 130 and again stores the result of the addition in the partial sum register 130.

Referring again to FIG. 4, the X-buffer 200 inputs a predetermined number of data elements of a first matrix stored therein to the multiple MAC units of the MAC unit array 100 in the X direction.

The Y-buffer 300 inputs a predetermined number of data elements of a second matrix stored therein to the multiple MAC units of the MAC unit array 100 in the Y direction.

Here, the X-buffer 200 is formed of two buffers 210 and 220, and while a predetermined number of pieces of matrix data is being output from one of the buffers, a predetermined number of pieces of matrix data may be stored in the other one. Also, the Y-buffer 300 is formed of two buffers 310 and 320, and while a predetermined number of pieces of matrix data is being output from one of the buffers, a predetermined number of pieces of matrix data may be stored in the other one.

That is, each of the X-buffer 200 and the Y-buffer 300 may be configured in the form of double buffering using even/odd buffers in order to ensure continuous operation of the MAC unit array 100.

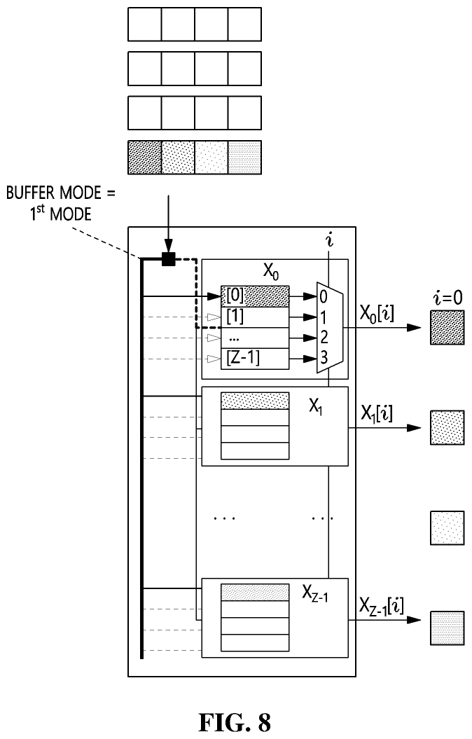

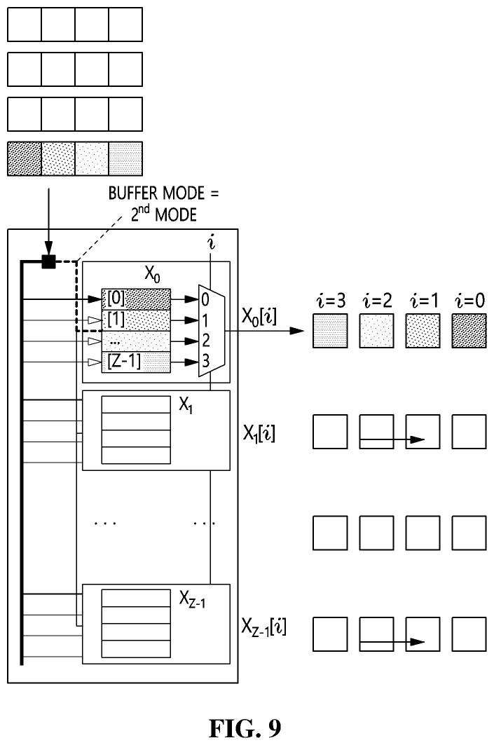

The X-buffer 200 and the Y-buffer 300 will be described in detail later with reference to FIG. 8 and FIG. 9.

The memory 400 stores the first matrix data and the second matrix data to be multiplied by each other.

The data loader 500 sequentially loads the first matrix data, which is to be input to the MAC unit array 100, from the memory 400 into the X-buffer 200 and sequentially loads the second matrix data, which is to be input to the MAC unit array 100, from the memory 400 into the Y-buffer 300.

For example, when the number of MAC units is 16 (Z=4), as illustrated in FIG. 4, the data loader 500 simultaneously reads four data elements of the first matrix and four data elements of the second matrix and supplies the same to the X-buffer 200 and the Y-buffer 300.

Here, according to an embodiment, the data loader 500 may load the matrix data into the buffers 200 and 300 in a preset first or second mode.

In order to process matrix multiplication operations in parallel using the above-described MAC unit array 100, the data loader 500 is required to load a ‘column’ of matrix A into the X-buffer 200 and load a ‘row’ of matrix B into the Y-buffer 300, as illustrated in FIG. 6.

If the number of MAC units is 16 (Z=4), when four data elements of a column of matrix A and four data elements of a row of matrix B are loaded and input to the 16 MAC units in parallel, as shown in FIG. 4, the partial sum (PSUM) of a total of 16 matrix elements may be processed at once.

In this method, the leftmost to rightmost columns of the four rows of matrix A illustrated in the upper left of FIG. 6 are input, and the topmost to bottommost rows of the four columns of matrix B are sequentially input, whereby the partial sums (PSUMs) are calculated. This may be the same as the process of inputting the topmost to bottommost rows of the four columns of matrix A^{T}, which is acquired by transposing matrix A.

When the above-described process is completed, the respective PSUM values of the 16 MAC units become 16 elements of matrix C (result values).

The data saver 600 stores third matrix data that is the result of multiplication of the first matrix and the second matrix, which is obtained using the MAC unit array 100, in the memory 400.

That is, the values stored in the respective partial sum registers 130 of the multiple MAC units forming the MAC unit array 100 may be simultaneously output and stored in the memory 400.

Subsequently, the bold-lined box 20 illustrated in FIG. 6 is shifted and the above-described processes are repeated, whereby the entire matrix multiplication operation for A×B is completed.

Here, all of the MAC unit array 100, the X-buffer 200, the Y-buffer 300, the data loader 500, and the data saver 600 perform operations in the form of a pipeline. Accordingly, simultaneous execution of the 16 MAC units (Z×Z=16) in each cycle is continuously performed, whereby the operation performance may be maximized.

FIG. 8 is an exemplary view of an operation when a buffer mode is a first mode according to an embodiment, and FIG. 9 is an exemplary view of an operation when the buffer mode is a second mode according to an embodiment.

Referring to FIG. 8, when a buffer mode is a first mode, the data loader 500 simultaneously loads Z pieces of data into Z First-In First-Out (FIFO) units X₀, X₁, X₂, . . . , X_{z-1} inside the X-buffer, respectively.

Here, each of the FIFO units have Z storage spaces, and when data output is started, data is sequentially output to each MAC unit in the order of 0, 1, 2, 3, . . .

Accordingly, in the first mode, the Z pieces of data, which are loaded at once by the data loader 500, are separately stored in the respective FIFO units X₀ to X_{z-1} in parallel. Then, when output from the FIFO units is started, the pieces of data output from the Z FIFO units in parallel are simultaneously supplied to the Z MAC units arranged in the column direction of the MAC unit array.

Referring to FIG. 9, when the buffer mode is a second mode, the data loader 500 loads all of the Z pieces of data into one of the Z FIFO units X₀, X₁, X₂, . . . , X_{z-1} inside the X-buffer.

Accordingly, in the second mode, the Z-pieces of data loaded at once by the data loader 500 are stored all together in one of the Z FIFO units X₀, X₁, X₂, . . . , X_{z-1}. Then, when output from the FIFO unit is started, the stored Z pieces of data are sequentially output one by one from the single FIFO unit and simultaneously supplied to the Z MAC units in one row of the MAC unit array.

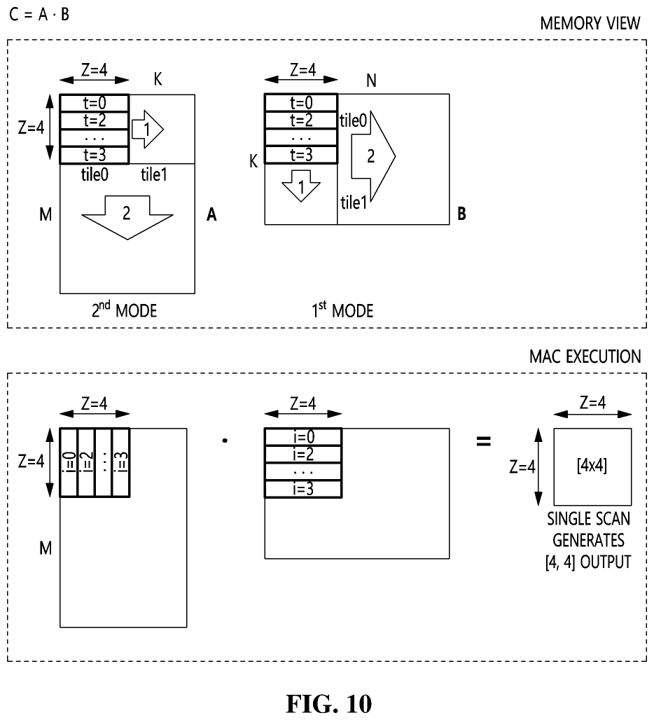

Hereinafter, an operation for performing each of the multiplication operations on matrix A and matrix B in Equation (1), which is described above in the description of the apparatus for a matrix multiplication operation according to an embodiment, will be described with reference to FIGS. 10 to 13, and the case in which α=1 and β=0 are set will be described for convenience of description.

In FIGS. 10 to 13, an example in which the MAC unit array 100 of the apparatus for a matrix multiplication operation is formed of 16 MAC units (Z=4) as shown in FIG. 4 is illustrated. Also, ‘memory view’ in FIGS. 10 to 13 shows the state in which the data of each of matrix A and matrix B is stored in memory, and ‘MAC execution’ in FIGS. 10 to 13 shows a process of loading the data of matrix A and the data of matrix B into the X-buffer 200 and the Y-buffer 300 and performing a multiplication operation thereon.

FIG. 10 is an exemplary view for explaining matrix multiplication A×B in an apparatus for a matrix multiplication operation according to an embodiment.

First, before the apparatus for a matrix multiplication operation starts operation, the X-buffer 200 and the Y-buffer 300 are set to a second mode and a first mode, respectively, for the operation A×B.

Subsequently, the operation of the apparatus for a matrix multiplication operation in each cycle may be represented as shown in Table 1 below.

TABLE 1

| t | operation |
|---|---|
| t = 0 | tile0.load.xy.evn |
| t = 1 | tile0.load.xy.evn |
| t = 2 | tile0.load.xy.evn |
| t = 3 | tile0.load.xy.evn |
| t = 4 | tile1.load.xy.evn/mac.evn(i = 0) |
| t = 5 | tile1.load.xy.evn/mac.evn(i = 0) |
| t = 6 | tile1.load.xy.evn/mac.evn(i = 0) |
| t = 7 | tile1.load.xy.evn/mac.evn(i = 0) |
| t = 8 | /mac.evn(i = 0) |
| t = 9 | /mac.evn(i = 0) |
| t = 10 | /mac.evn(i = 0) |
| t = 11 | /mac.evn(i = 0) |
| t = 12 | /store.psum[0:3] |
| t = 13 | /store.psum[0:3] |
| t = 14 | /store.psum[0:3] |
| t = 15 | /store.psum[0:3] |

When t is 0 (t=0), the first four pieces of data, among the pieces of data in tile0 of matrix A, and the first four pieces of data, among the pieces of data in tile0 of matrix B, are loaded and stored in the even buffers 210 and 310 of the X-buffer 200 and the Y buffer 300. This operation may be coded and represented as “t=0: tile0.load.xy.evn”, as shown in Table 1.

When t=1, t=2, and t=3, the pieces of data in tile of matrix A and the pieces of data in tile0 of matrix B are sequentially read and stored in the even buffers 210 and 310. This operation may be coded and represented as “t=1: tile0.load.xy.evn”, “t=2: tile0.load.xy.evn”, and “t=3: tile0.load.xy.evn”, as shown in Table 1.

When t=4, t=5, t=6, and t=7, the pieces of data in tile1 of matrix A and the pieces of data in tile1 of matrix B are sequentially read and stored in the odd buffers 220 and 320, and at the same time, the 16 MAC units (Z×Z=16) simultaneously operate in parallel using the data in the even buffers 210 and 310, thereby generating 16 partial sums (PSUMs).

Here, the pieces of data stored in the X-buffer 200 in the second mode are output one by one from the FIFO unit in the order of i=0, 1, 2, and 3.

The pieces of data stored in the Y-buffer 300 in the first mode are output at once from the four FIFO units.

Accordingly, the pieces of data are supplied to the 16 MAC units 100, and the 16 MAC units 100 perform operations in each cycle, thereby generating partial sum (PSUM) values.

When four cycles of operations of the MAC unit array 100 are completed, a 4×4 output matrix C corresponding to the result values are generated in the PSUM registers 130 of the MAC unit array 100, and this matrix may be stored at the location of matrix C in the memory 400.

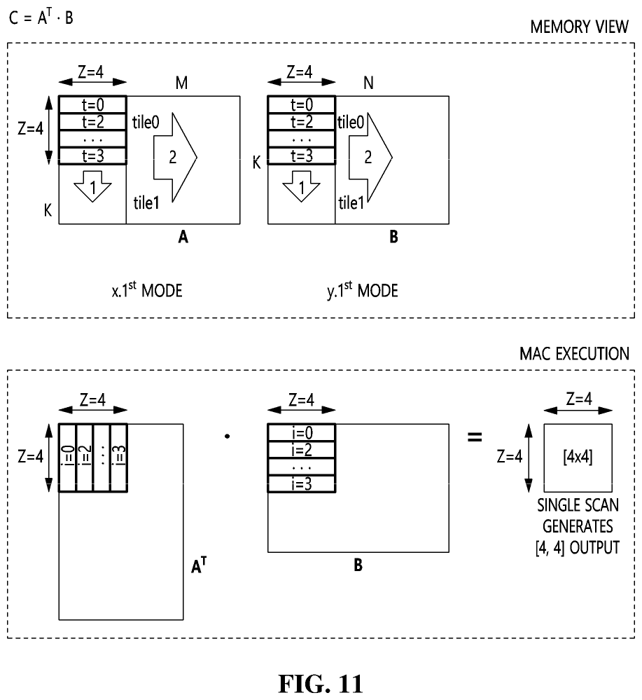

FIG. 11 is an exemplary view for explaining matrix multiplication A^{T}×B in the apparatus for a matrix multiplication operation according to an embodiment.

First, when it is necessary to transpose matrix A before the apparatus for a matrix multiplication operation starts operation, both the X-buffer 200 and the Y-buffer 300 are set to the first mode for the operation A^{T}×B.

Excluding the buffer operation mode, the order of the operations for calculating A^{T}×B is the same as that shown in Table 1.

However, the location from which tile1 of matrix A is loaded after the loading of tile0 of matrix A is set by shifting the tile window downwards in matrix A, as illustrated in FIG. 11. This is because it is necessary to transpose matrix A.

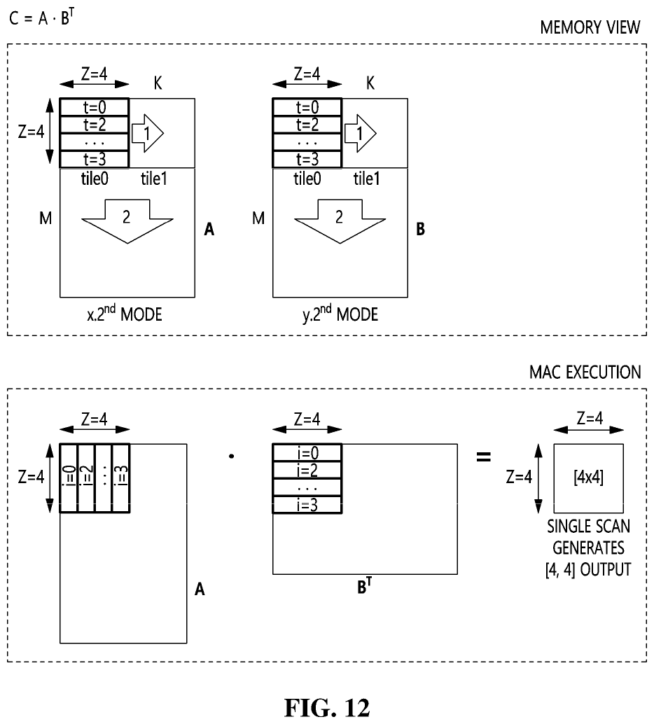

FIG. 12 is an exemplary view for explaining matrix multiplication A×B^{T} in the apparatus for a matrix multiplication operation according to an embodiment.

First, when it is necessary to transpose matrix B before the apparatus for a matrix multiplication operation starts operation, both the X-buffer 200 and the Y-buffer 300 are set to the second mode for the operation A×B^{T}.

Excluding the buffer operation mode, the order of the operations for calculating A×B^{T} is the same as that shown in Table 1.

However, the location from which tile1 of matrix B is loaded after the loading of tile0 of matrix B is set by shifting the tile window rightwards in matrix B, as illustrated in FIG. 12. This is because it is necessary to transpose matrix B.

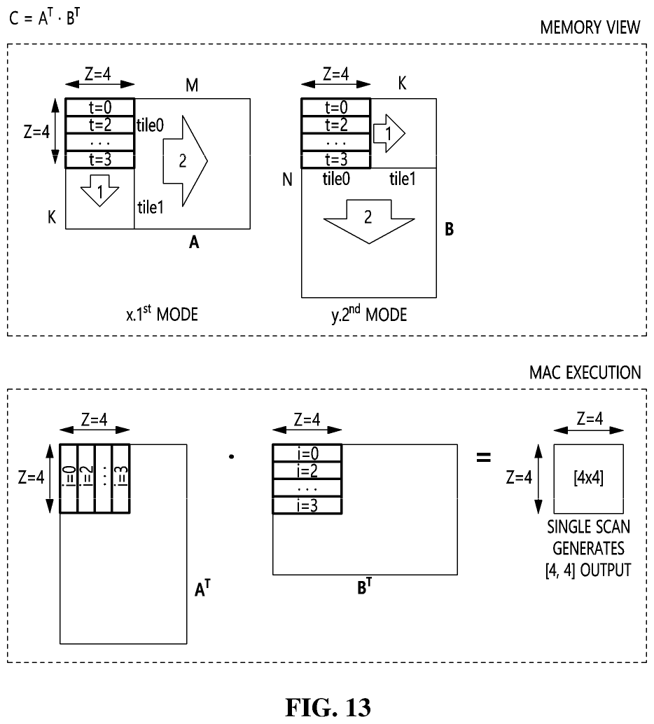

FIG. 13 is an exemplary view for explaining matrix multiplication A^{T}×B^{T} in the apparatus for a matrix multiplication operation according to an embodiment.

First, when it is necessary to transpose matrices A and B before the apparatus for a matrix multiplication operation starts operation, the X-buffer 200 and the Y-buffer 300 are set to the first mode and the second mode, respectively, for the operation A^{T}× B^{T}.

Excluding the buffer operation mode, the order of the operations for calculating A^{T}×B^{T} is the same as that shown in Table 1.

However, the locations from which tile1 of matrix A and tile1 of matrix B are loaded after the loading of tile0 of matrix A and tile0 of matrix B are respectively set by shifting the tile window downwards in matrix A and shifting the tile window rightwards in matrix B, as illustrated in FIG. 13. This is because it is necessary to transpose matrices A and B.

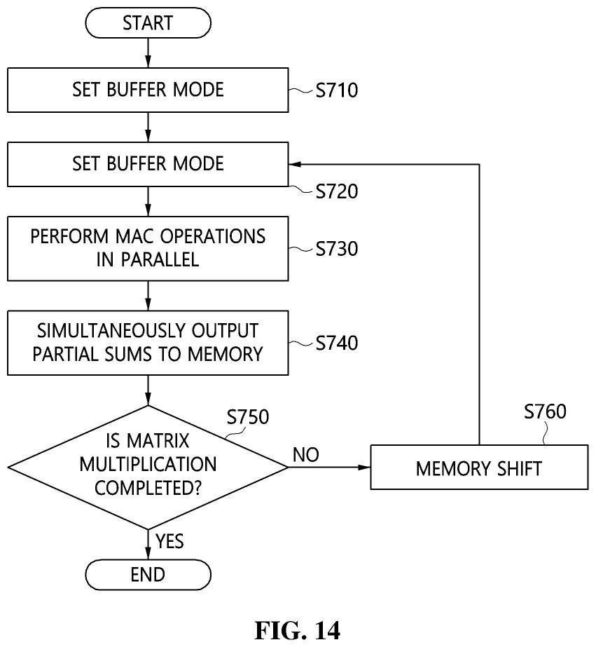

FIG. 14 is a flowchart for explaining a method for a matrix multiplication operation according to an embodiment.

Referring to FIG. 14, the method for a matrix multiplication operation according to an embodiment may include loading data of a first matrix and data of a second matrix from memory into an X buffer and a Y buffer, respectively, at step S720 and performing simultaneous MAC operations in parallel on the data of the first matrix, which is loaded into the X buffer, and the data of the second matrix, which is loaded into the Y buffer, multiple times at step S730.

Here, the MAC operation may comprise multiplying the value output from the X buffer and the value output from the Y buffer, adding the result value of the multiplication and a previously calculated partial sum, and updating the partial sum with the result value of the addition.

Here, loading the data may comprise storing the matrix data in the X buffer or the Y buffer in a first mode or a second mode.

To this end, setting the buffer mode of the X buffer or the Y buffer at step S710 has to be performed in advance in the method for a matrix multiplication operation according to an embodiment.

Here, in the first mode, the pieces of matrix data may be simultaneously loaded into the respective First-In First Out (FIFO) units inside the X buffer or the Y buffer in parallel, and in the second mode, the pieces of matrix data may be loaded into one of the FIFO units inside the X buffer or the Y buffer.

Here, loading the data at step S720 may comprise storing the data of the first matrix in the X buffer by loading the same in the first mode and storing the data of the second matrix in the Y buffer by loading the same in the second mode when multiplication of the first matrix and the second matrix is performed.

Here, loading the data at step S720 may comprise storing the data of the first matrix in the X buffer by loading the same in the second mode and storing the data of the second matrix in the Y buffer by loading the same in the second mode when multiplication of the transpose matrix of the first matrix and the second matrix is performed.

Here, loading the data at step S720 may comprise storing the data of the first matrix in the X buffer by loading the same in the first mode and storing the data of the second matrix in the Y buffer by loading the same in the first mode when multiplication of the first matrix and the transpose matrix of the second matrix is performed.

Here, loading the data at step S720 may comprise storing the data of the first matrix in the X buffer by loading the same in the second mode and storing the data of the second matrix in the Y buffer by loading the same in the first mode when multiplication of the transpose matrix of the first matrix and the transpose matrix of the second matrix is performed.

Here, each of the X buffer and the Y buffer is formed of two buffers, and while a predetermined number of pieces of matrix data is being output from one of the buffers, a predetermined number of pieces of matrix data may be stored in the other one of the buffers.

The method for a matrix multiplication operation according to an embodiment may further include simultaneously outputting partial sums, which are the results of performing the simultaneous MAC operations in parallel multiple times, and storing the partial sums in the memory at step S740.

Subsequently, the box 20 of matrix data is shifted at steps S750 and S760, as illustrated in FIG. 6, and the above-described processes are repeated, whereby the matrix multiplication A×B is completed.

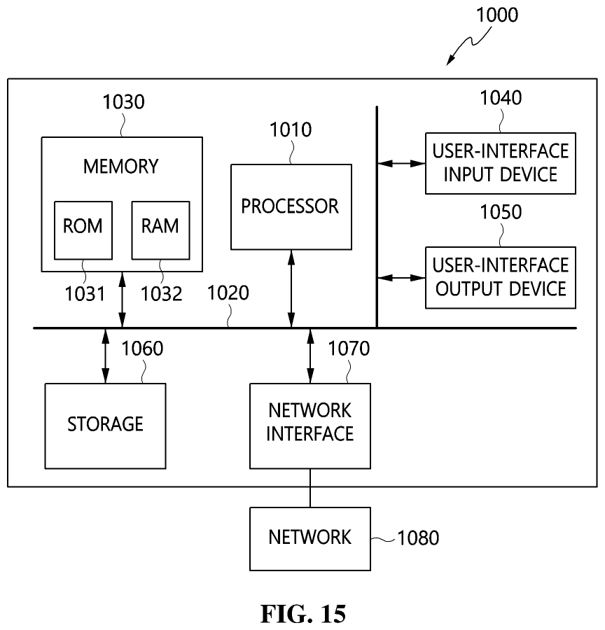

FIG. 15 is a view illustrating a computer system configuration according to an embodiment.

The apparatus according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, a matrix multiplication operation based on the BLAS library may be efficiently processed.

According to the disclosed embodiment, latency caused by processing a transpose operation in a matrix multiplication operation based on the BLAS library may be prevented.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for a matrix multiplication operation, comprising:
memory for storing data of a first matrix and data of a second matrix;
an X buffer for storing the data of the first matrix;
a Y buffer for storing the data of the second matrix;
multiple operation units for performing Multiply-and-Accumulate (MAC) operations in parallel on data input from the X buffer and the Y buffer; and
a data loader for storing the data of the first matrix read from the memory in the X buffer and storing the data of the second matrix read from the memory in the Y buffer.

2. The apparatus of claim 1, wherein each of the multiple operation units for performing the MAC operations in parallel includes
a multiplier for multiplying a value output from the X buffer and a value output from the Y buffer;
a partial sum register; and
an adder for adding an output value of the multiplier and a value stored in the partial sum register and again storing a result value of addition in the partial sum register.

3. The apparatus of claim 1, wherein the data loader is configured to
store pieces of matrix data in the X buffer or the Y buffer in a first mode or a second mode,
simultaneously load the pieces of matrix data into respective First-In First-Out (FIFO) units inside the X buffer or the Y buffer in parallel in the first mode, and
load the pieces of matrix data into one of the FIFO units inside the X buffer or the Y buffer in the second mode.

4. The apparatus of claim 3, wherein, when multiplication of the first matrix and the second matrix is performed, the data loader stores the data of the first matrix in the X buffer by loading the data in the first mode and stores the data of the second matrix in the Y buffer by loading the data in the second mode.

5. The apparatus of claim 3, wherein, when multiplication of a transpose matrix of the first matrix and the second matrix is performed, the data loader stores the data of the first matrix in the X buffer by loading the data in the second mode and stores the data of the second matrix in the Y buffer by loading the data in the second mode.

6. The apparatus of claim 3, wherein, when multiplication of the first matrix and a transpose matrix of the second matrix is performed, the data loader stores the data of the first matrix in the X buffer by loading the data in the first mode and stores the data of the second matrix in the Y buffer by loading the data in the first mode.

7. The apparatus of claim 3, wherein, when multiplication of a transpose matrix of the first matrix and a transpose matrix of the second matrix is performed, the data loader stores the data of the first matrix in the X buffer by loading the data in the second mode and stores the data of the second matrix in the Y buffer by loading the data in the first mode.

8. The apparatus of claim 1, wherein each of the X buffer and the Y buffer is formed of two buffers, and while a predetermined number of pieces of matrix data is being output from one of the buffers, a predetermined number of pieces of matrix data is stored in the other one of the buffers.

9. The apparatus of claim 2, further comprising:
a data saver for simultaneously outputting values stored in the respective partial sum registers of the multiple operation units for performing the MAC operations in parallel and storing the values in the memory.

10. A method for a matrix multiplication operation, comprising:
loading data of a first matrix and data of a second matrix from memory into an X buffer and a Y buffer, respectively; and
performing simultaneous Multiply-and-Accumulate (MAC) operations in parallel on the data of the first matrix, which is loaded into the X buffer, and the data of the second matrix, which is loaded into the Y buffer, multiple times.

11. The method of claim 10, wherein the MAC operation comprises
multiplication of a value output from the X buffer and a value output from the Y buffer,
addition of a result value of the multiplication and a previously calculated partial sum, and
update of the partial sum with a result value of the addition.

12. The method of claim 10, wherein:
loading the data comprises storing pieces of matrix data in the X buffer or the Y buffer in a first mode or a second mode,
the pieces of matrix data are simultaneously loaded into respective First-In First-Out (FIFO) units inside the X buffer or the Y buffer in parallel in the first mode, and
the pieces of matrix data are loaded into one of the FIFO units inside the X buffer or the Y buffer in the second mode.

13. The method of claim 12, wherein loading the data comprises storing the data of the first matrix in the X buffer by loading the data in the first mode and storing the data of the second matrix in the Y buffer by loading the data in the second mode when multiplication of the first matrix and the second matrix is performed.

14. The method of claim 12, wherein loading the data comprises storing the data of the first matrix in the X buffer by loading the data in the second mode and storing the data of the second matrix in the Y buffer by loading the data in the second mode when multiplication of a transpose matrix of the first matrix and the second matrix is performed.

15. The method of claim 12, wherein loading the data comprises storing the data of the first matrix in the X buffer by loading the data in the first mode and storing the data of the second matrix in the Y buffer by loading the data in the first mode when multiplication of the first matrix and a transpose matrix of the second matrix is performed.

16. The method of claim 12, wherein loading the data comprises storing the data of the first matrix in the X buffer by loading the data in the second mode and storing the data of the second matrix in the Y buffer by loading the data in the first mode when multiplication of a transpose matrix of the first matrix and a transpose matrix of the second matrix is performed.

17. The method of claim 10, wherein each of the X buffer and the Y buffer is formed of two buffers, and while a predetermined number of pieces of matrix data is being output from one of the buffers, a predetermined number of pieces of matrix data is stored in the other one of the buffers.

18. The method of claim 11, further comprising:
simultaneously outputting partial sums, which are results of performing the simultaneous MAC operations in parallel multiple times, and storing the partial sums in the memory.

19. An apparatus for a matrix multiplication operation, comprising:
memory for storing data of a first matrix and data of a second matrix;
an X buffer for storing the data of the first matrix;
a Y buffer for storing the data of the second matrix;
multiple operation units for performing Multiply-and-Accumulate (MAC) operations in parallel on data input from the X buffer and the Y buffer;
a data loader for storing the data of the first matrix read from the memory in the X buffer and storing the data of the second matrix read from the memory in the Y buffer; and
a data saver for simultaneously outputting values stored in respective partial sum registers of the multiple operation units for performing the MAC operations in parallel and storing the values in the memory.

20. The apparatus of claim 19, wherein the data loader is configured to
store pieces of matrix data in the X buffer or the Y buffer in a first mode or a second mode,
simultaneously load the pieces of matrix data into respective First-In First-Out (FIFO) units inside the X buffer or the Y buffer in parallel in the first mode, and
load the pieces of matrix data into one of the FIFO units inside the X buffer or the Y buffer in the second mode.
